(19) United States
(12) Patent Application Publication
(10) Pub. No.: US 2016/0105699 A1
(43) Pub. Date: Apr. 14, 2016

(54) System and Method for Audience Media Planning for Tune-In

(71) Applicant: VIACOM INTERNATIONAL INC., New York, NY (US)

(72) Inventor: Fabio LUZZI, New York, NY (US)

(21) Appl. No.: 14/512,045

(22) Filed: Oct. 10, 2014

(51) Int. Cl. H04N 21/25; H04N 21/81; H04N 21/258; H04N 21/2668; H04N 21/222; H04N 21/235

(52) U.S. Cl. CPC H04N 21/252; H04N 21/222; H04N 21/235; H04N 21/25883; H04N 21/25891; H04N 21/2668; H04N 21/812

(57) ABSTRACT

A system and method determines an audience media planning for tune-in for a target program. The method includes receiving viewing information for a plurality of programs watched by a plurality of viewers where each of the programs has a respective character information. The method includes generating affinity information between each of the programs among other programs where the affinity information indicates a similarity value based upon the character information. The method includes receiving an input of a target program having a target character information. The method includes determining a first probability value between the target program and a first one of the programs indicating a first likelihood that a first one of the viewers of the first program will watch the target program.

### BACKGROUND INFORMATION

Television networks broadcast a variety of programs with each program including a respective type of content. One objective in airing a program is to maximize a number of viewers who watch the program. For example, a program with a high viewership may warrant a higher cost for commercials aired during breaks thereof whereas a program with a low viewership may warrant a lower cost for the same commercial time. To increase the viewership of the program, the television network may advertise its programs.

Television networks employ different methods to advertise their programs. In a first example, a television network may utilize a broad sweeping approach where a target program is advertised across all or a wide variety of other programs aired. This method allows viewers of these other programs who are potentially interested in watching the target program to view the advertisement for the target program. However, in this example, there is a high financial requirement as, in addition to these viewers who are potentially interested in the target program (potentially interested viewers), the advertising of the target program is also shown to a large number of uninterested or minimally interested viewers. In a second example, the television network may attempt to identify a target audience or pool of potentially interested viewers to which the target program should be promoted. This example may focus the dissemination of the advertisements for the target program by locating advertisements during programs determined to attract large numbers of viewers potentially interested in the target program. However, this method may also entail as high or even a higher cost than the first method as the identification of the programs attracting large numbers of potentially interested viewers will often include the use of outside advertising agencies and/or market studies. If, alternatively, the television network decreases costs associated with advertising the target program, the consequential reduction in exposure of the ads to potentially interested viewers will leave many viewers unaware of the target program.

Furthermore, there are many different media formats over which the advertising for the target program may be disseminated. For example, the target program may be promoted through traditional publications (e.g., billboards, magazines, newspapers, etc.), broadcast media (e.g., television and radio) and online (Internet based advertising). However, there are costs and drawbacks to each of these types of media, particularly when the advertising large numbers of the people exposed to the ads are not potentially interested fed to uninterested viewers.

Thus, there is a need for a cost-effective approach to advertising a target program to large numbers of potentially interested viewers while minimizing resources expended on uninterested viewers.

### BRIEF DESCRIPTION OF THE DRAWINGS

FIG. 1 shows an audience media planning system according to the exemplary embodiments.

FIG. 2 shows an audience media planning server according to the exemplary embodiments.

FIG. 3 shows an affinity map according to the exemplary embodiments.

FIG. 4 shows a method for generating an AMP approach to advertise a target program according to the exemplary embodiments.

### DETAILED DESCRIPTION

The exemplary embodiments may be further understood with reference to the following description and the related appended drawings, wherein like elements are provided with the same reference numerals. The exemplary embodiments are related to a system and method for determining an audience media planning (AMP) approach for a target program based upon viewing information. Specifically, the viewing information may include viewing patterns and probability models that indicate whether a viewer of a different program is likely to watch the target program. Based upon the likelihood that the viewer will watch the target program, the AMP approach may be determined. Furthermore, the AMP approach may also include incorporation of other information that may further determine aspects of the AMP approach such as information related to the viewer beyond viewing habits. In addition, an automated mechanism may be provided to provide the AMP approach to be used based on the various information.

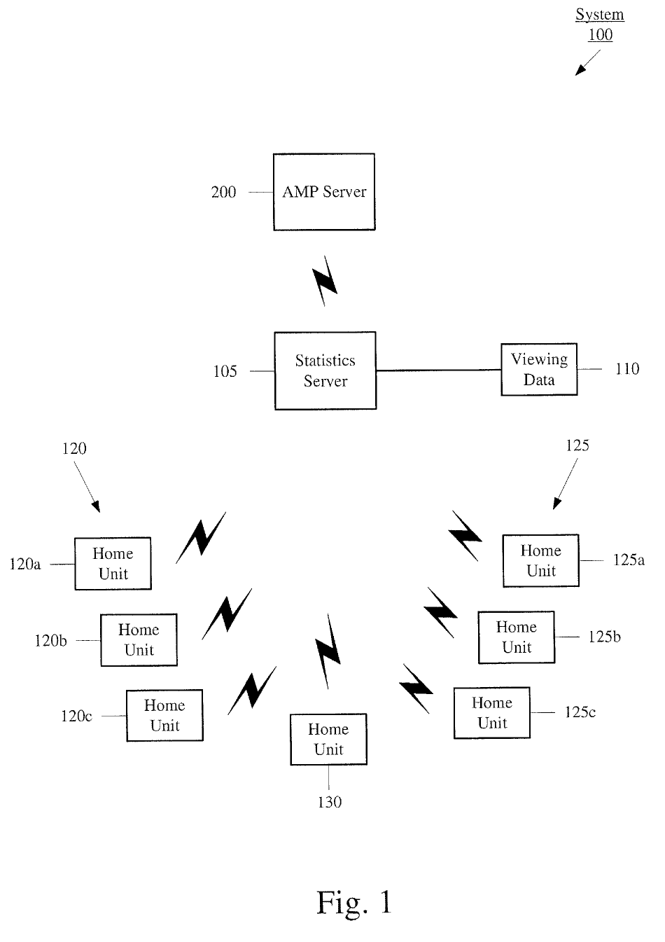

FIG. 1 shows an AMP system 100 according to the exemplary embodiments. The AMP system 100 includes a statistics server 105 that receives viewing information and an AMP server 200 that determines the AMP approach to be used for a target program based on the viewing information and other related information (e.g., viewer information). As shown, the statistics server 105 may receive viewing data 110 provided by viewers (e.g., as self reported the viewers) and/or may receive viewing information from a plurality of home units 120, 125, 130 which monitor user viewing habits.

In a particular example, the viewing information from the statistics server 105 may include ratings generated by audience measurement systems using, for example, viewer diaries and Set Meters.

The viewer diaries include data on viewing habits self-recorded by members of the audience so that through targeting various demographics, assembled statistical models may provide a rendering of the audiences of any given show. Accordingly, the statistics server 105 may receive viewing information as viewing data 110 that may substantially correspond to the viewer diaries. The viewer diaries may be compiled in any manner that records the viewing habits of the viewer and the household associated with the viewer diary. For example, a viewer diary may be a proprietary program in which a viewer records the programs watched over a period of time. In another example, a viewer diary may be any recording program that may be interpreted by the statistics server 105 to determine the programs watched by a viewer or viewers over the period of time. Subsequently, the viewer diary may be transmitted (e.g., electronically, physically, etc.) to the statistics server 105.

The Set Meters provide a more technological approach to generating the viewing information. Specifically, the Set Meters are devices connected to televisions in selected homes to monitor the programming that is actually watched by the viewers. Accordingly, the statistics server 105 may also receive viewing information from the home units 120, 125, 130 that, in one example, substantially corresponds to the Set Meters. The home units 120, 125, 130 collect the viewing habits of the home and transmit the information to the statistics server 105 using any known connection manner (e.g., wired or wireless connection). The technology-based home unit system enables market researchers to study television viewing habits on a time basis (e.g., per minute, per hour, etc.), determine moments when viewers change viewing (e.g., change channels), determine moments when viewers stop viewing (e.g., turn off their television), etc. Because the home units 120, 125, 130 may be activated whenever viewers are watching television programming, the viewer information may be provided continually so long as the television associated with the home unit is being used.

It should be noted that the use of the Set Meters is only exemplary. Those skilled in the art will understand that the viewing information may be generated using any manner. For example, the statistics server 105 may be a proprietary component that generates proprietary viewing information that is used by the AMP server 200. Other examples that may be sources of the viewing information may include set-top boxes and digital (on-line) video consumption meters.

The statistics server 105 may further provide other related information. For example, providers of the viewing data 110 and/or each home unit 120, 125, 130 may require viewer data such as identification information of the viewers in the household such as name(s), age(s), number of viewers, nationality, etc. Specifically, a home that provides the information to generate the ratings may have such a requirement. In another example, providers of the viewing data 110 and/or each home unit 120, 125, 130 may also provide usage information of the viewers. The usage information may include media type information, subscription information, etc. that indicates, among other things, Internet use, magazine/newspaper subscriptions, etc. In this regard, other related information may also be collected by the statistics server 105.

FIG. 1 further shows that the home units 120 may include three home units 120a-c while the home units 125 may include three home units 125a-c. The home units 120a-c may represent a set of home units that watch a first program while the home units 125a-c may represent a set of home units that watch a second program. The home unit 130 may represent a home unit that watches both the first and second programs. As will be described in further detail below, the viewing information and other related information provided to the AMP server 200 from the statistics server 200 may form the basis in which to determine an AMP approach for the programs.

It should be noted that the number and organization of the home units 120, 125, 130 in the system 100 of FIG. 1 is only exemplary. Those skilled in the art will understand that there may be any number of home units that transmit viewing information to the statistics server 105. It should also be noted that the home units 120, 125, 130 being associated with individual households is only exemplary. For example, a single household may include more than one home unit that provides the viewing information to the statistics server 105.

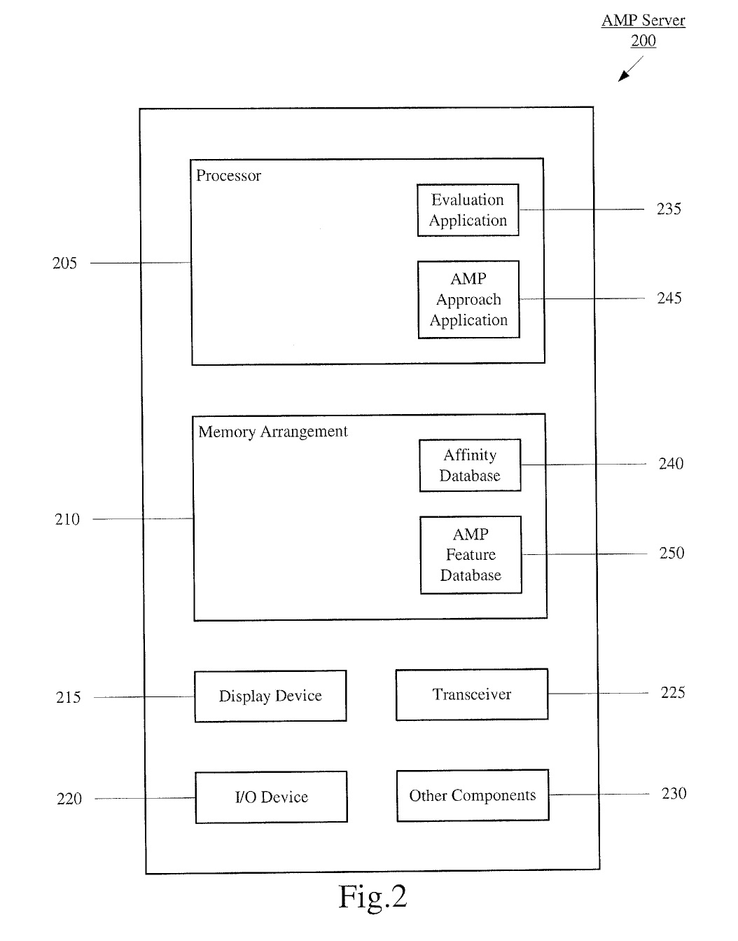

FIG. 2 shows the AMP server 200 according to the exemplary embodiments. As discussed above, the AMP server 200 receives the viewing information and other related information from the statistics server 105. The AMP server 200 is configured to automatically generate an AMP approach for a target program based upon the received information and the AMP server 200 includes a processor 205, a memory arrangement 210, a display device 215, an input/output device 220, a transceiver 225, and other components 230.

Initially, it should be noted that, although the AMP server 200 is represented as a single device, this is only exemplary. Those skilled in the art will understand that the AMP server 200 may also be represented as a plurality of different devices interconnected with each other to collectively perform the functionalities as described herein for the single device.

The processor 205 is configured to execute a plurality of applications corresponding to the described functionalities. It should be noted that the applications may be embodied as executable programs executed by the processor 295 to cause the processor 205 to perform the functionalities. However, this is exemplary only and the functionalities associated with the applications may also be represented as separate incorporated components of the AMP server 200 (e.g., an integrated circuit with or without firmware), may be a modular component coupled to the AMP server 200 (e.g., a hardware or software plug-in), or a combination thereof.

The memory arrangement 210 may be a hardware component configured to store data related to operations performed by the AMP server 200. For example, a memory device (e.g., hard drive, tape drive, flash memory, etc.) included in the AMP server 200 or to which the AMP server 200 has access, may store the information received from the statistics server 105. The display device 215 may be a hardware component configured to show information or interfaces to a user while the I/O device 220 may be hardware and/or software components configured to receive inputs from a user and output corresponding data. Specifically, the display device 215 and the I/O device 220 may enable the user to provide corresponding information for certain functionalities. In a particular example, the I/O device 220 may enable a user to provide information of a target program to be evaluated for the AMP approach to be used therefor.

As discussed above, the processor 205 may execute a plurality of applications to perform the various functionalities of the AMP server 200. As illustrated, the processor 205 executes an evaluation application 235 and an AMP approach application 245. As will be described in further detail below, the evaluation application 235 analyzes information concerning the target program (target program information) and information corresponding to viewers of other programs (potentially interested viewer information) to rank the other programs based on a number of potentially interested viewers reached by each of the programs and the degree of potential interest in the target program of the viewers of these other programs. The evaluation application 235 also divides the viewers into subcategories based on a level of their potential interest in the target program. The AMP approach application 245 provides a second feature of the exemplary embodiments designing an AMP approach for the target program based on the potentially interested viewer information including the number of viewers in the various subcategories viewing the various programs and the target program information.

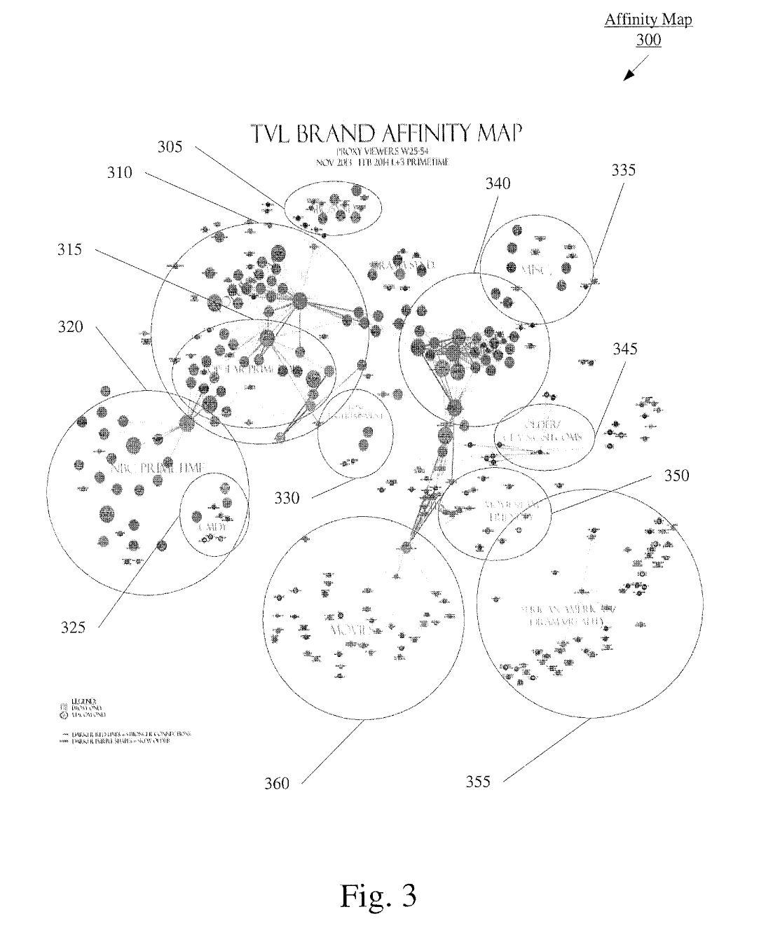

The evaluation application 235 may receive the viewing information from the statistics server 105 (e.g., via the transceiver 225). As discussed above, the viewing information may include viewing habits corresponding to the home units 120, 125, 130. As shown in the system 100, the viewers corresponding to the home units 120a-c may watch a first program while the viewers corresponding to home units 125a-c may watch a second program. The first and second programs may have affinity information associated therewith. For example, the first and second programs may have tags or descriptors associated therewith. Such affinity information may be stored, for example, in an affinity database 240. In a particular embodiment, the evaluation application 235 may analyze the affinity information and generate an affinity map that is stored in the affinity database 240. It should be noted that the evaluation application 235 may also incorporate the viewing data 110 into the affinity map if available. The affinity map will be described with regard to FIG. 3.

It should again be noted that the use of only the first and second programs is exemplary only and the viewing information has a greater likelihood of including a large number of programs. Thus, the affinity map may include a representation of each and every program included within the viewing information.

A set of program characteristics related to each of the programs (program information) is included in the viewing information and may include information on the type of program and the major characteristics of the program. For example, a first program may be a situation comedy taking place in an urban area having a female lead. This information would be included in the program information for the first program. There may be several programs whose program information includes this same set of characteristics (characteristics set 1). Accordingly, the evaluation application 235 may determine that programs having characteristics set 1 have a highest affinity with each other. In another example, a second program may include program information indicating that the second program is a situation comedy taking place in an urban area having a male lead (characteristics set 2). Accordingly, the evaluation application 235 may determine that this second program has a high affinity to programs having the characteristics set 1. However, this second program would have a lower affinity with programs having characteristics set 1 than with programs having characteristics set 2. The evaluation application 235 determines an affinity for each program relative to the target program based on a comparison of the target program information and the program information for each of the programs. The evaluation application 235 also determines an affinity for all of the other programs included in the viewing information provided by the statistics server 105 with each other.

The program information may be determined in a variety of manners. In a first manner, the specific character information may be provided by the distributor of the program. For example, the owner or administrator of the program may include the relevant program information including the specific character information. In a second manner, the program information may be generated by a third party unrelated to the owner/administrator of the program. For example, a reviewer of the program may include relevant content information providing an objective characterization of the program. In another example, an administrator or user of the AMP server 200 may enter the specific character information via the I/O device 220. In a third manner, the evaluation application 235 may be configured with a sub-application that automatically determines the program information of the programs.

It should be noted that the program information may also be retrieved from historical viewing data. For example, historical viewing data may also be included in the affinity database 240. Thus, the evaluation application 235 may initially determine whether historical viewing data for a particular program already exists. In this manner, the evaluation application 235 may not be required to determine the program information for the program but instead simply retrieves this information. However, when no historical viewing data exists, the evaluation application 235 may perform the above noted mechanism to determining the program information. In a particular example, the evaluation application 235 determines proxy program information for a program that has no associated historical viewing information.

Once the program information for each program included in the viewing information has been determined and properly associated, the evaluation application 235 generates an affinity map. As shown in FIG. 3, an affinity map 300 according to the exemplary embodiments is a graphical representation of the affinity of programs watched over a period of time. These programs may be represented by the individual circles within the affinity map 300. In a first example, the individual circles may be groups of programs having the certain identity in their program data (e.g., a specified degree of matching in their specific characteristics). The size of the individual circles may depend, for example, on a number of programs grouped therein. In a second example, the size of each circle may depend on the popularity of an individual program or a group of programs represented by the circle. Thus, although the individual circles are referred to herein as “programs,” those skilled in the art will understand that each circle may represent either an individual program or a group of programs. In a broader sense, the programs may be part of a set according to an overall character. These sets may be the larger circles which are represented as sets 305-360. Thus, each of the sets 305-360 may include a plurality of programs. Although the sets 305-360 may be used herein, it should be noted that the evaluation application 235 may utilize a specific evaluation process for each individual circle rather than with the sets 305-360.

The programs may include affinities with respect to other programs. In a specific example, a close proximity of a first program to a second program may indicate a strong affinity therebetween while a more distant relation between circles represents a weaker affinity. For example, a program in the set 305 has a higher affinity with a program in the set 310 and a lower affinity with a program in the set 355. In a further example, a program in the set 315 is also within the set 310 which indicates that the program of the set 315 has a high affinity with a program in the set 310.

Furthermore, the affinity map 300 may include interconnections between the different programs. A previously noted example may be from a simple textual analysis of the specific character information. However, the exemplary embodiments may utilize a more thorough analysis in determining the affinity interconnections between the programs. Specifically, a clustering technique may be used to avoid multi-collinearity by performing a variable reduction in which a logistic regression may be applied.

Initially, the evaluation application 235 may perform a filtering functionality. The filtering functionality may be used to efficiently analyze the different programs in the viewing information that further eliminates a need for further processing. Specifically, within the time frame for which the viewing information relates, there may be programs that are substantially irrelevant to the analysis. For example, a special program that airs a single time (e.g., a live events such as sporting events, etc.) may be removed from the analysis. That is, the AMP approach may be incapable of being properly applied. In another example, a less popular program may be removed from the analysis. For example, the evaluation application 235 may be provided with a predetermined popularity threshold that indicates whether the program is to be considered for further processing or not. The predetermined popularity threshold may be manually or automatically determined based on the target program to which the AMP approach applies. That is, a target program that has a high expectation of high viewership may have a higher popularity threshold whereas a target program that has a high expectation of low viewership may have a lower popularity threshold. Therefore, less popular programs may be removed from the range of programs in which the AMP approach is to apply. However, it should be noted that this initial filtering functionality is exemplary only and the evaluation application 235 will, for example, consider all programs included in the viewing information.

The evaluation application 235 may perform a variable reduction for the programs in the viewing information to avoid multicollinearity using clustering techniques. Those skilled in the art will understand that multicollinearity is a statistical phenomenon where two or more predictor variables in a regression model are highly correlated. When such a condition exists, one predictor variable may be linearly predicted from the other predictor variables with a non-trivial degree of accuracy. Furthermore, coefficient estimates of the regression may change erratically in response to small changes in the model or the data. Although multicollinearity does not reduce the predictive power or reliability of the model as a whole, it does affect calculations regarding individual predictors. That is, a regression model with correlated predictors may indicate an affinity of describing a set of predictors that predicts an outcome variable. However, multicollinearity does not provide valid results about any individual predictor or about whether predictors are redundant with respect to others. When the predictors relate to programs in the viewing information, it is clear how multicollinearity is to be avoided as the target program is compared to individual programs in the viewing information. Therefore, multicollinearity is a condition that is avoided by the evaluation application 235.

In an effort to avoid multicollinearity, the evaluation application 235 performs a variable reduction using clustering techniques. Those skilled in the art will understand that variable reduction relates to a process of selecting a subset of relevant features for use in model construction. Accordingly, an assumption in variable reduction is that there are features that may be redundant (features that provide no further information than currently selected features) or irrelevant (features that provide no useful information in any context). When categorizing programs, there may be descriptors or tags that may not provide sufficient information to draw the affinities with respect to each other. Furthermore, variable reduction provides various benefits when constructing predictive models such as improved model interpretability, shorter training times, and enhanced generalization by reducing overfitting. Variable reduction may also be useful to show which features are important for prediction and their relations to the variables.

One manner of performing the variable reduction is through the use of clustering techniques. Affinities between the programs may therefore be clustered to determine an affinity to a target program. Specifically, clustering relates to grouping a set of objects (e.g., programs) so that objects in the same group or cluster are more similar to each other than to those in other groups or clusters. When related to the programs, this relates to the specific program information of the programs. There are various known manners of performing clustering techniques such as clusters with small distances among the cluster members, dense areas of the data space, intervals or particular statistical distributions, etc. As shown in the affinity map 300 generated by the evaluation application 235, the clustering technique that utilizes the distances between the clusters may therefore be used. That is, the variable reduction and clustering techniques performed on the viewing information by the evaluation application 235 generate the affinity map 300 that initially filters out unwanted programs, avoids multicollinearity, and determines the affinities of the programs to one another. For example, the affinity map 300 includes differently shaded affinity lines between the programs in which a darker shade indicates a higher affinity whereas a lighter shade indicates a lower affinity.

The evaluation application 235 may also receive information related to a target program (e.g., via the transceiver 225 and/or the I/O device 220). That is, the target program for which the AMP approach is to be determined may be provided to the evaluation application 235. The evaluation application 235 may again determine the target program information in a manner substantially similar to that discussed above. That is, the evaluation application 235 determines whether historical viewing data exists from which the target program information may be retrieved or the evaluation application 235 may determine proxy character information that accurately describes the target program within the context of the affinity map 300.

When the target program information is determined, the target program may be compared to the other programs in the affinity map 300 to determine a probability that viewers of a program in the affinity map 300 are likely to watch the target program. Specifically, the evaluation application 235 may perform a logistic regression or a series of logistic regression modeling techniques to predict this behavior. The evaluation application 235 may perform the logistic regression for each program in the affinity map such that a likelihood parameter is determined for every viewer indicating a likelihood that the viewer will watch the target program.

Those skilled in the art will understand that a logistic regression is a probabilistic statistical classification model used to predict a response from a predictor so that an outcome may be predicted for a categorical dependent variable based upon predictor variables. That is, logistic regression may be used in estimating the parameters of a qualitative response model. The probabilities of the outcomes may be modeled as a function of the predictor variables using a logistic function. It should be noted that logistic regression may utilize dependent variables that are binary (number of available categories is two) or more than two in which the logistic regression is a multinomial logistic regression. Thus, the evaluation application 235 may perform a logistic regression to measure an affinity between a categorical dependent variable (e.g., specific character information) and independent variables through probability scores as the predicted values of the dependent variable.

According to the exemplary embodiments, the evaluation application 235 may perform the logistic regression for the target program to generate a plurality of viewership groups. For example, the evaluation application 235 may generate quintiles. An analysis of the programs in the affinity map 300 may identify a first group of select viewers who have a high likelihood of watching the target program (a first quintile) based on their viewing habits in regard to corresponding programs in the affinity map 300. The analysis may further identify second, third, fourth, and fifth groups (second, third, fourth and fifth quintiles, respectively) of select viewers in descending order of their likelihood of watching the target program, again based upon their viewing habits of the corresponding programs in the affinity map 300. In this manner, a first quint for the first select viewers may be grouped; a second quint for the second select viewers may be grouped; a third quint for the third select viewers may be grouped; etc.

Therefore, the first quint has a highest likelihood that the viewers therein will watch the target program while the fifth quint has a lowest likelihood that the viewers therein will watch the target program. The likelihood may be arranged in ranges such that the first quint has viewers from a first predetermined likelihood (e.g., maximum value) to a second predetermined likelihood (e.g., lower than the maximum value); the second quint may have viewers from the second predetermined likelihood to a third predetermined likelihood (e.g., lower than the second predetermined likelihood); and so forth. It should be noted that the evaluation application 235 may additional generate a final group that includes viewers who are non-viewers of the target program. That is, the final group may be viewers of programs in the affinity map 300 who are determined to have zero likelihood or some negligible likelihood of watching the target program.

Furthermore, the evaluation application 235 may generate viewing propensity models for each quint that illustrate a likelihood or probability that the viewers in the quint will watch the target program. That is, the viewing propensity models may be used as a basis to predict a behavior of the viewers in the quint. Specifically, the behavior prediction relates to whether the viewer of the quint will watch the target program based on the same viewer watching a different program mapped in the affinity map 300. These viewing propensity models may again be generated for each viewer within the quints when the more thorough approach is utilized. In addition, the evaluation application 235 may generate a first viewing propensity model for the first quint which has the highest likelihood of watching the target program. Every subsequent quint may have a respective viewing propensity model generated by the evaluation application 235 based on the first viewing propensity model of the first quint. It should be noted that the viewing propensity models may also be generated based on an immediately prior quint's model or models for adjacent quints.

The results of the logistic regression that generates the viewership groups and the viewing propensity models may be provided from the evaluation application 235 to the AMP approach application 245. The AMP approach application 245 may determine the AMP approach to be used for each of the viewership groups. In a more thorough manner, the AMP approach application 235 may determine an AMP approach to be used for each viewer in one or more of the viewership groups. In particular, each viewer of the programs may represent groups of viewers in the general public within a particular geographic location and/or demographic group. Thus, the application of the AMP approach to a viewer in the affinity map 300 may in fact be an application to groups of viewers.

The AMP approach application 245 may utilize a AMP approach 250 stored in the memory arrangement. The AMP approach 250 may include predetermined parameters and ranges thereof for a particular feature to be included in the AMP approach that is selected for the target program for the selected viewer. When related to the viewership groups and their corresponding quint, the AMP approach application 245 may first determine a set of qualifying features to be included in the AMP approach based on the AMP approach 250. For example, when the viewership group is in the first quint, more aggressive advertisement features may be used. These advertisements features may include traditional advertisements in periodicals, television commercials, Internet advertisements, etc. The AMP approach application 245 may also determine a frequency in which the advertisement features are to be used. Thus, with the first quint and a more aggressive approach, the selected advertisements features may be recommended as being shown frequently to provide a higher probability that the intended viewers of the first quint will see the advertisement for the target program. Again, the AMP approach application 245 may perform a further analysis for each viewer within the quint and tailor an AMP approach therefor. In this way, a plurality of AMP approaches may be generated for each viewership group and/or viewer included in the programs of the affinity map 300 based upon the viewing information provided from the statistics server 105.

In a specific example, the home units 120a-c relate to viewers who watch a first program while home units 125a-c relate to viewers who watch a second program. The target program has been analyzed and the affinity map 300 includes the first and second programs. The evaluation application 235 has further determined the relevance of the target program within the affinity map 300. As a result, the evaluation application 235 has determined that viewers of the first program are in the first quint while viewers of the second program are in the third quint. The evaluation application 235 forwards this resulting data to the AMP approach application 245. The AMP approach application 245 references the AMP approach 250 and determines an appropriate AMP approach to be used for viewers of the first and third quints.

It should be noted that the above exemplary embodiments relate to viewers who watch only the first program (e.g., home units 120a-c) or who watch only the second program (e.g., home units 125a-c). However, there will also be viewers who watch both the first and second programs (e.g., home unit 130). The evaluation application 235 and the AMP approach application 245 may be further configured to provide detailed analyses for viewers who watch multiple programs. Specifically, the exemplary embodiments and the above described processes may incorporate multiple viewing behavior to further tailor and design the AMP approach.

Furthermore, as described, the statistics server 105 and/or a different input to the AMP server 200 may provide other related information of the viewers. This other related information may also be used to further tailor the AMP approaches generated. For example, demographic information along with corresponding usage information may indicate that a particular viewer watches a particular program but is otherwise incapable of viewing commercials outside the program. The demographic and usage information may also indicate that the viewer does not utilize the Internet but receives periodicals. In such a specific scenario, the AMP approach application 245 may filter the features to eliminate those that are commercials and/or Internet related. In another example, demographic information along with corresponding usage information may indicate that a particular viewer watches commercials and uses the Internet. In a similar manner, the AMP approach application 245 may filter the features to include those that are commercials and/or Internet related.

According to the exemplary embodiments, the AMP server 200 receives viewing information regarding programs watched by viewers corresponding to the home units 120, 125, 130 and also receives other related information from the statistics server 105 such as identification and usage information. The evaluation application 235 determines affinity information for programs in the viewing information to generate, for example, the affinity map 300. The target program for which the AMP approach is to be determined for each viewer may also be provided to the evaluation application 235 to determine its relation within the affinity map 300. Upon the viewership information and the viewing propensity models being determined, the AMP approach application 245 determines the proper AMP approaches to be used. The AMP server 200 may provide the results in a variety of manners. For example, a table including the AMP approaches may be provided on the display device 215. In another example, the final automated deliverable from the AMP server 200 may include a plurality of sections: viewing propensity models including opportunities and optimized media plans; detailed profiling; significant differences among viewing segments; content consumption; viewing habits; geographic analysis; co-viewing behavior; etc.

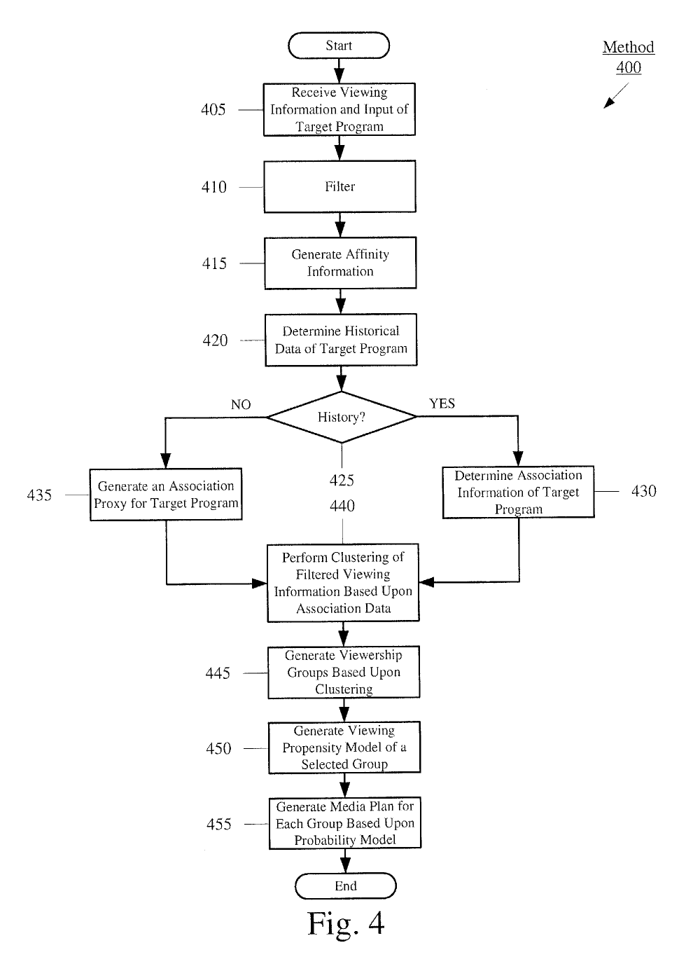

FIG. 4 shows a method 400 for generating an AMP approach to advertise a target program according to the exemplary embodiments. The method 400 relates to the functionalities performed by the evaluation application 235 using the affinity database 240 and the AMP approach application 245 using the AMP approach 250 of the AMP server 200. The method 400 will be described with regard to the system 100 of FIG. 1 and the AMP server 200 of FIG. 2 with specific descriptions regarding the home units 120, 125.

In step 405, the AMP server 200 receives the viewing information from the statistics server 105 as well as an input for a target program. Prior to the method 400 being performed by the AMP server 200, the statistics server 105 compiles the viewing information and other related information. As discussed above, the viewing information may be derived from a plurality of sources including the viewing data 110 and the home units 120, 125, 130. However, it should again be noted that there may be significantly more sources from which the viewing information may be generated such as further home units. In step 410, the evaluation application 235 filters the viewing information. Specifically, programs that have no effect on the affinity information between the programs may be removed from consideration. For example, specials or live events may be filtered out. However, it should again be noted that the filtering step is optional.

In step 415, the evaluation application 235 generates affinity information. As discussed above, this may include generating an affinity map 300 that provides a representation of affinities between the programs in the viewing information. These affinities may be based upon, for example, the specific character information of the programs. As discussed above, one manner of determining these affinities is performing a variable reduction to avoid multicollinearity using clustering techniques.

In step 420, the evaluation application 235 searches for any historical viewing data of the target program. For example, the target program may be a returning program (e.g., an ensuing season of the show). In step 425, the evaluation application 235 determines whether there is any historical data. If historical data exists, the evaluation application 235 continues the method 400 to step 430 where the association information corresponding to the target program is retrieved. Specifically, the specific character information of the target program is retrieved. However, if no historical data exists, the evaluation application 235 continues the method 400 to step 435 where the evaluation application 235 generates an association proxy for the target program. Thus, the evaluation application 235 may receive or determine a specific character information to associate with the target program.

In step 440, the evaluation application 235 performs a clustering of the filtered viewing information based on the specific character information. As discussed above, the clustering may avoid the multicollinearity with regard to the target program. The important aspects of the specific character information may also be selected through the variable reduction to determine the affinity relationships with the other programs relative to the target program. Thus, in step 445, the evaluation application 235 generates viewership groups based on the clustering in which each group has an affinity ranking relative to the target program.

In step 450, the evaluation application 235 generates a viewing propensity model for a selected group such as the first quint to compute the affinity of each viewer within the group to the target program. The model reaches an optimum solution by comparing the viewing habits of each one of the viewers in the selected group with the viewing habits of each one of the highest viewers of the target program using viewing data points. The affinity may also be described as a propensity of liking the target program. Thus, the affinity may be expressed in the form of a probability in which viewers are assigned a probability value based on an adherence to a multidimensional (multi-program) viewing profile determined by the model.

In step 455, the AMP approach application 245 may receive the resulting information from the evaluation application 235 to generate a media plan or an AMP approach for each group based on the probability model. For example, the first quint may have a first AMP approach generated therefor based on the resulting information including the viewing propensity model and the quints beyond the first may have a refined AMP approach based upon the first AMP approach and corresponding the viewing propensity model.

It should be noted that the method 400 above in the described order is only exemplary. As also discussed previously, the AMP server 200 may perform each step in a variety of manners that enable the AMP approach application 245 to ultimately generate the AMP approaches for each viewer or group.

The exemplary embodiments provide a system and method for determining an audience media plan for a target program. Specifically, the audience media plan may relate to a manner of advertising or promoting the target program. The audience media plan may be based on probability models that indicate a probability that a viewer of a first program is likely to watch the target program. By initially receiving viewing information from a statistics server, an audience media plan server according to the exemplary embodiments generates probability models (e.g., in an affinity map) and correlates a relationship for the target program therein. Subsequently, the viewers of each program in the affinity map may have an audience media plan approach designed and tailored therefor.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
receiving, by an audience media planning (AMP) server, viewing information for a plurality of programs watched by a plurality of viewers, each of the programs having a respective character information;
generating, by the AMP server, affinity information between each of the programs among other programs, the affinity information indicating a similarity value based upon the character information;
receiving, by the AMP server, an input of a target program having a target character information;
determining, by the AMP server, a first probability value between the target program and a first one of the programs indicating a first likelihood that a first one of the viewers of the first program will watch the target program.

2. The method of claim 1, further comprising:
generating, by the AMP server, a first AMP approach to advertise the target program to the first viewer based upon the first probability value.

3. The method of claim 2, further comprising:
determining, by the AMP server, a second probability value between the target program and a second one of the programs indicating a second likelihood that a second one of the viewers of the second program will watch the target program.

4. The method of claim 3, wherein the first likelihood is greater than the second likelihood.

5. The method of claim 4, further comprising:
generating, by the AMP server, a second AMP approach to advertise the target program to the second viewer based upon the second probability value and the first AMP approach.

6. The method of claim 1, wherein the affinity information is represented as an affinity map including a respective graphical representation for each of the programs, each of the graphical representations being spaced apart from other graphical representations based upon the similarity value.

7. The method of claim 2, further comprising:
receiving, by the AMP server, viewer information for each of the viewers; and
modifying, by the AMP server, the first AMP approach based upon the viewer information of the first viewer.

8. The method of claim 7, wherein the viewer information includes at least one of demographic information and media usage information.

9. The method of claim 1, wherein the affinity information is generated based upon a variable reduction through clustering techniques to avoid multicollinearity.

10. The method of claim 2, wherein the first AMP approach includes at least one of printed advertisements, television commercials, and Internet advertisements.

11. An audience media planning (AMP) server, comprising:
a receiver configured to receive viewing information for a plurality of programs watched by a plurality of viewers, each of the programs having a respective character information, the transceiver further configured to receive an input of a target program having a target character information; and
a processor configured to generate affinity information between each of the programs among other programs, the affinity information indicating a similarity value based upon the character information, the processor further configured to determine a first probability value between the target program and a first one of the programs indicating a first likelihood that a first one of the viewers of the first program will watch the target program.

12. The AMP server of claim 11, wherein the processor is further configured to generate a first AMP approach to advertise the target program to the first viewer based upon the first probability value.

13. The AMP server of claim 12, wherein the processor is further configured to determine a second probability value between the target program and a second one of the programs indicating a second likelihood that a second one of the viewers of the second program will watch the target program.

14. The AMP server of claim 13, wherein the first likelihood is greater than the second likelihood.

15. The AMP server of claim 14, wherein the processor is further configured to generate a second AMP approach to advertise the target program to the second viewer based upon the second probability value and the first AMP approach.

16. The AMP server of claim 11, wherein the affinity information is represented as an affinity map including a respective graphical representation for each of the programs, each of the graphical representations being spaced apart from other graphical representations based upon the similarity value.

17. The AMP server of claim 12, wherein the receiver is further configured to receive viewer information for each of the viewers and wherein the processor is further configured to modify the first AMP approach based upon the viewer information of the first viewer.

18. The AMP server of claim 17, wherein the viewer information includes at least one of demographic information and media usage information.

19. The AMP server of claim 11, wherein the affinity information is generated based upon a variable reduction through clustering techniques to avoid multicollinearity.

20. A non-transitory computer readable storage medium with an executable program stored thereon, wherein the program instructs a microprocessor to perform operations comprising:
receiving, by an audience media planning (AMP) server, viewing information for a plurality of programs watched by a plurality of viewers, each of the programs having a respective character information;
generating, by the AMP server, affinity information between each of the programs among other programs, the affinity information indicating a similarity value based upon the character information;
receiving, by the AMP server, an input of a target program having a target character information;
determining, by the AMP server, a first probability value between the target program and a first one of the programs indicating a first likelihood that a first one of the viewers of the first program will watch the target program.
